(19) United States
(12) Patent Application Publication
(10) Pub. No.: US 2017/0020320 A1
(43) Pub. Date: Jan. 26, 2017

(54) Stackable Magnetic Hanger

(71) Applicant: Tristar Products, Inc., Fairfield, NJ (US)

(72) Inventor: Jorge Prats, Rver Edge, NJ (US)

(21) Appl. No.: 15/073,649

(22) Filed: Mar. 18, 2016

Related U.S. Application Data
(60) Provisional application No. 62/136,341, filed on Mar. 20, 2015.

(51) Int. Cl. A47G 25/38; H01F 7/02

(52) U.S. Cl. CPC A47G 25/38; H01F 7/0252

(57) ABSTRACT

A stackable hanger include a first faceplate and second faceplate. The first faceplate is composed of a ferromagnetic material and includes a protrusion. The second faceplate is composed of a ferromagnetic material and includes a recess. Further, at least one magnetic section is positioned between the first faceplate and second faceplate. Stacking each hanger involves inserting the protrusion of the first faceplate of a hanger into the recess of the second faceplate of another hanger to expand the overall thickness of the stacked hangers to support heavier articles of clothing. Each hanger is secured to another by at the least one magnetic section.

### RELATED APPLICATIONS

This application is related to Provisional Application No. 62/136,341 filed 20 Mar. 2015 by the same inventor as the present application and assigned to the same assignee as the present application. The contents of the aforementioned Provisional Application No. 62/136,341 filed 20 Mar. 2015 are incorporated herein as if fully recited herein.

### TECHNICAL FIELD

The present invention relates to the field of hangers, and more particularly, to a stackable hanger.

### BACKGROUND OF THE INVENTION

Various stackable hangers are known in the art. In many of these solutions, the entire front face of the hanger is convex and the entire back face is concave. The hangers then nest in each other. As a result, the hangers must have a minimum thickness to accommodate the concave-convex shape and yet carry weight.

In other solutions, the stackable hangers are substantially flat on both sides. Such hangers are stacked atop one another and in some solutions secured using a separate connecting member.

Thus, there is a clear need for a stackable hanger with a smaller thickness, thereby allowing the stacking and storing of more hangers in restricted spaces. There is a further need for a stackable hanger with a connector member that minimizes the components and thickness of the stackable hanger.

### SUMMARY OF EMBODIMENTS OF THE INVENTION

A stackable hanger is disclosed including a first faceplate and second faceplate. The first faceplate is composed of a ferromagnetic material and includes a protrusion. The second faceplate is composed of a ferromagnetic material and includes a recess. Further, at least one magnetic section is positioned between the first faceplate and second faceplate. The process of stacking each hanger involves inserting the protrusion of the first faceplate of a hanger into the recess of the second faceplate of another hanger. The process can be repeated to expand the overall thickness of the stacked hangers to support heavier articles of clothing. Each hanger is secured to another by at the least one magnetic section.

### BRIEF DESCRIPTION OF THE DRAWINGS

A further understanding of the invention can be obtained by reference to a preferred embodiment set forth in the illustrations of the accompanying drawings. Although the illustrated embodiment is merely exemplary of systems and methods for carrying out the invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

The detailed description makes reference to the accompanying figures wherein:

FIG. 1 illustrates a front view of a stackable hanger in accordance with the preferred embodiment of the present invention;

FIG. 2 illustrates a front view of the stackable hanger shown in FIG. 1 with the first faceplate removed;

FIG. 3 illustrates a side view of the stackable hanger shown in FIG. 1;

FIG. 4A illustrates a front view of the stackable hanger shown in FIG. 1 with a section A-A;

FIG. 4B illustrates a cross-sectional side view of the stackable hanger shown in FIG. 4A along a section A-A;

FIG. 5A illustrates a front view of the stackable hanger shown in FIG. 1 with a section B-B and dimensions in accordance with the preferred embodiment of the present invention;

FIG. 5B illustrates a side view of the stackable hanger shown in FIG. 5A with dimensions in accordance with the preferred embodiment of the present invention;

FIG. 5C illustrates a cross-sectional top view of the stackable hanger shown in FIG. 5A along a section B-B with dimensions in accordance with the preferred embodiment of the present invention;

FIG. 6 illustrates a top perspective view of the stackable hanger shown in FIG. 1;

FIG. 7 illustrates a perspective view of the stackable hanger shown in FIG. 6;

FIG. 8 illustrates a perspective view of a stacked stackable hanger in accordance with the preferred embodiment of the present invention; and

FIG. 9 illustrates a top view of the stacked stackable hanger shown in FIG. 7.

Other objects, features, and characteristics of the present invention, as well as methods of operation and functions of the related elements of the structure and the combination of parts, will become more apparent upon consideration of the following detailed description with reference to the accompanying drawings, all of which form part of this specification.

### DETAILED DESCRIPTION OF A PREFERRED EMBODIMENT

A detailed illustrative embodiment of the present invention is disclosed herein. However, techniques, methods, processes, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

None of the terms used herein, including “body” and “section” are meant to limit the application of the invention. The terms are used to illustrate the preferred embodiment and are not intended to limit the scope of the invention. Similarly, the use of these terms is not meant to limit the scope or application of the invention, as the invention is versatile and can be utilized in many applications, as will be apparent in light of the disclosure set forth herein

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the words “herein,” “above,” “below,” and words of similar import, when used in this application, shall refer to this application as a whole and not to any particular portions of this application. Where the context permits, words in the Detailed Description of the Embodiments using the singular or plural number may also include the plural or singular number respectively. The word “or,” in reference to a list of two or more items, covers all of the following interpretations of the word: any of the items in the list, all of the items in the list, and any combination of the items in the list. The following presents a detailed description of the preferred embodiment of the present invention with reference to the figures.

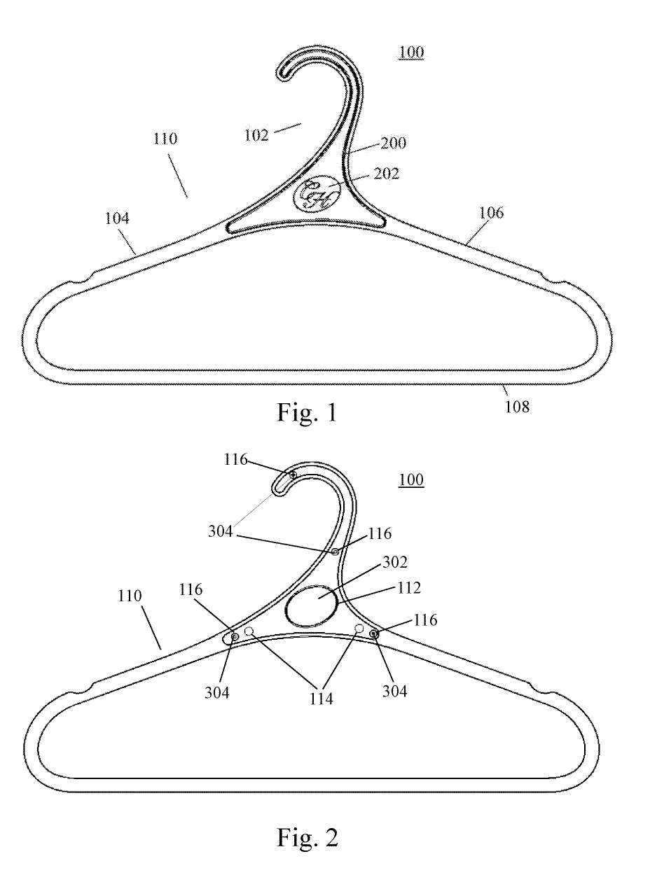

FIG. 1 shows a front view of hanger 100 according to the preferred embodiment of the present invention. Hanger 100 includes hanger body 110. Hanger body 110 includes hook section 102, first arm 104, second arm 106, and cross-bar 108. Hook section 102 is similar in shape and size to hooks utilized on conventional clothes hangers arranged to be supported on a pole or rod. As shown, first arm 104 and second arm 106 generally form an inverted V-shape and are slightly concave. This arrangement is configured to support an article of clothing including, but not limited to dresses, shirts, and/or coats. Articles of clothing including, but not limited to pants and shirts, can also be supported on hanger 100 by folding over cross-bar 108. In the preferred embodiment of the present invention, hanger body 110 is composed of a plastic material that is flocked with plastic fibers to improve the grip of hanger 100 on articles of clothing. It would be obvious to one of ordinary skill in the art to use other materials including, but not limited to wood and metal without departing from the spirit of the present invention.

As shown in FIG. 1, first faceplate 200 is attached to hanger body 110. First faceplate 200 is preferably composed of a ferromagnetic material. Further, first faceplate 200 includes protrusion 202. Protrusion 202 extends outward and preferably enables indicia to be placed on it, such as letters, numbers, patterns, designs, and/or pictures for desired customization. In the preferred embodiment, first faceplate 200 includes connector members (not shown) to removably couple first faceplate 200 to hanger body 110. It would obvious to one of ordinary skill in the art to permanently the first faceplate to the hanger body during assembly without departing from the spirit of the present invention.

In FIG. 2, first faceplate 200 (shown in FIG. 1) has been detached from hanger 100 to illustrate hanger 100 including a second faceplate (labeled 300 in FIG. 7). Hanger body 110 further includes recess aperture 112, at least one connector member aperture 114, and at least one magnetic section 116. Second faceplate is preferably attached to a back side of hanger body 110 which is shown in detail with reference to FIG. 7. Second faceplate includes recess 302. In FIG. 2, recess 302 is visible through recess aperture 112 of hanger body 110. Further, second faceplate 300 includes at least one connector member 304. In FIG. 2, connector member 304 is visible through connector member aperture 114 of hanger body 110. In the preferred embodiment, connector member 304 includes a boss connector. The first faceplate (not shown) includes a corresponding connector to mate with the boss connector. Recess 302 of second faceplate 300 is preferably configured to mate with a protrusion of a first faceplate.

Hanger body 110 further includes at least one magnetic section 116. In the preferred embodiment, two magnetic sections are utilized and include apertures in hanger body 110. Magnets are preferably placed in magnetic section 116. The magnets are secured in a position to allow first faceplate to attach to second faceplate 300.

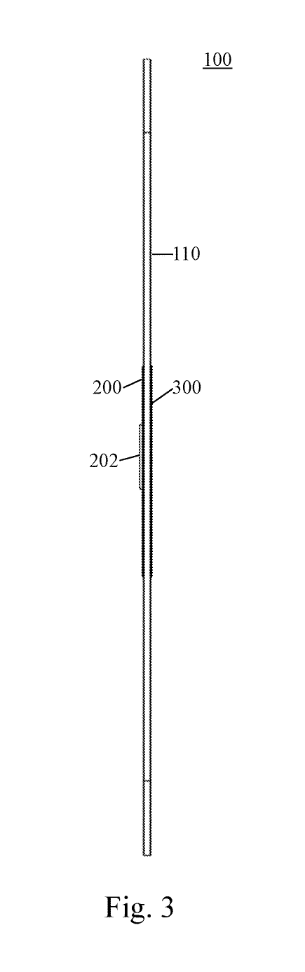

FIG. 3 depicts a side view of hanger 100 of the preferred embodiment. As shown, the thickness of first faceplate 200 and second faceplate 300 is substantially less than the thickness of hanger body 110 to minimize the overall thickness of hanger 100. As noted, protrusion 202 of first faceplate 200 extends outward from first faceplate 200.

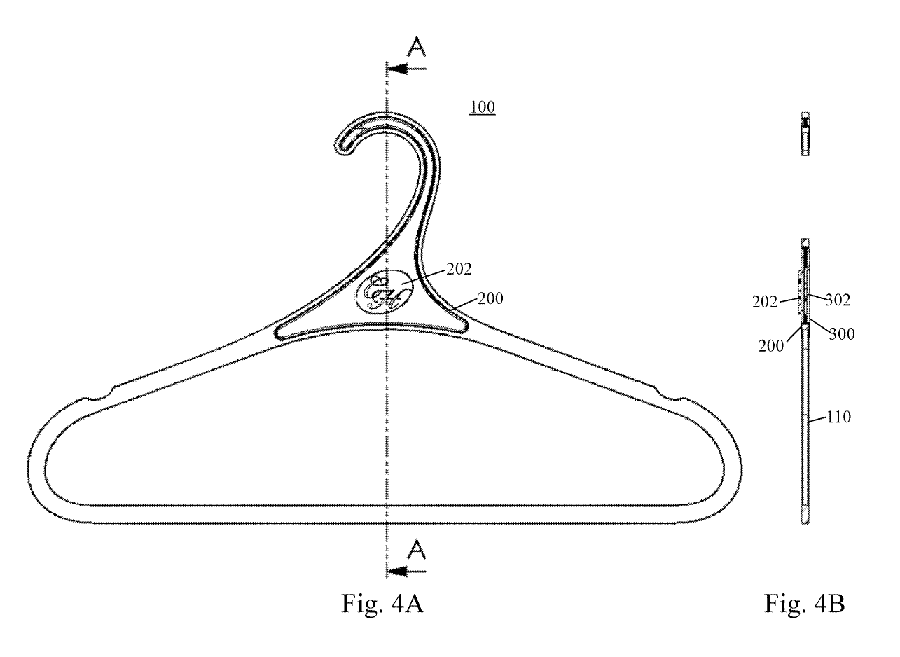

As shown in FIGS. 4A and 4B, recess 302 of second faceplate 300 is configured to mate with protrusion 202 of first faceplate 200.

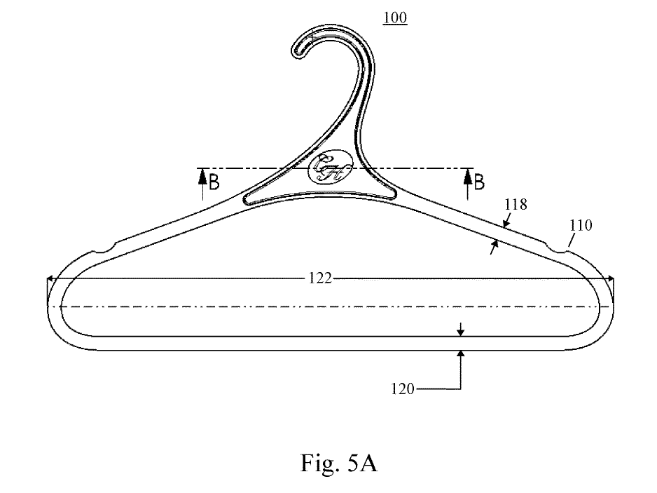

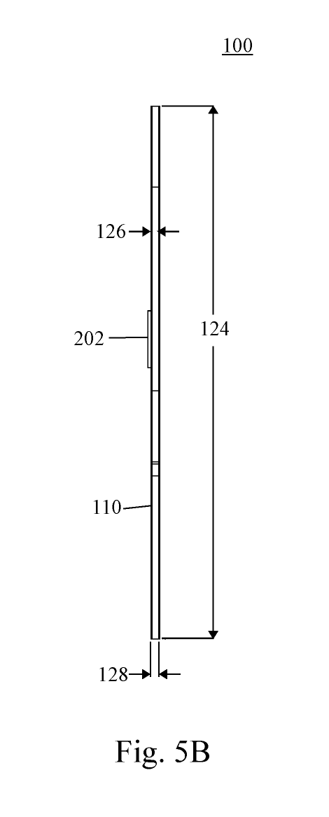

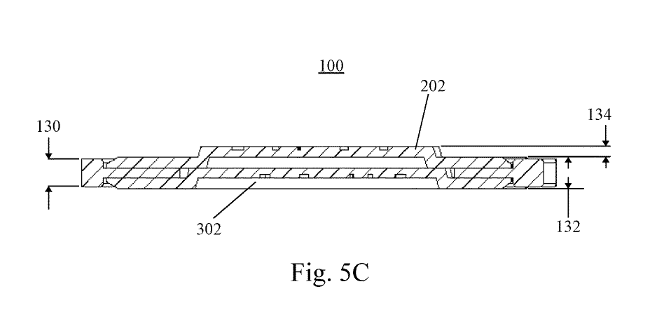

FIGS. 5A, 5B, and 5C depict exemplary dimensions of hanger 100. In FIG. 5A the measurement of distance 118 is 11 millimeters (0.433 inches). The measurement of distance 120 is also 11 millimeters (0.433 inches). The measurement of distance 122 is 430 millimeters (16.929 inches). Turning next to FIG. 5B, the measurement of distance 124 is 247.34 millimeters (9.738 inches). The measurement of distance 126 is 4.5 millimeters (0.177 inches) and the measurement of distance 128 is 4 millimeters (0.157 inches). As shown in FIG. 5C, the measurement of distance 130 is 4 millimeters (0.157 inches). The measurement of distance 132 is 4.5 millimeters (0.177 inches). Finally, the measurement of distance 134 is 1.5 millimeters (0.059 inches).

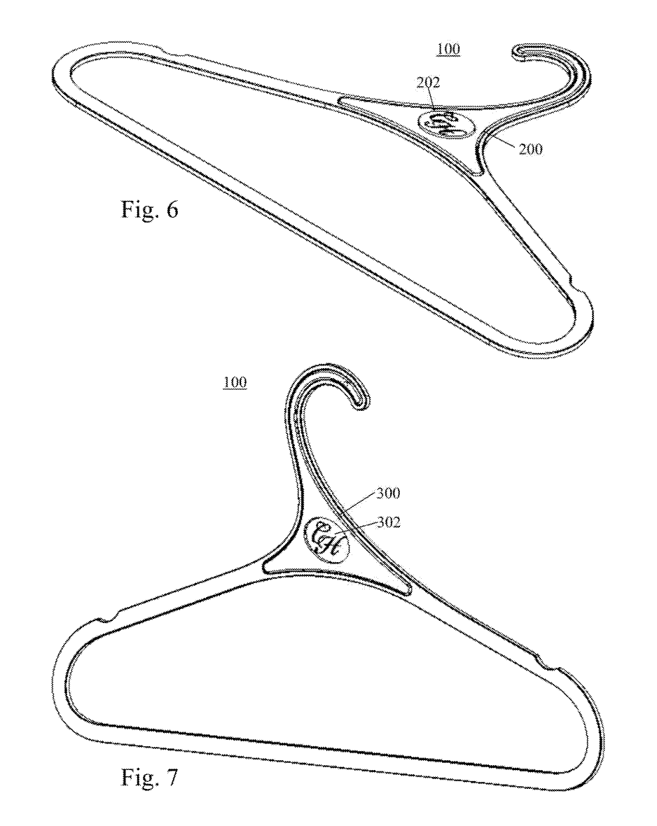

In FIGS. 6 and 7, the perspective views show the minimal thickness of hanger 100.

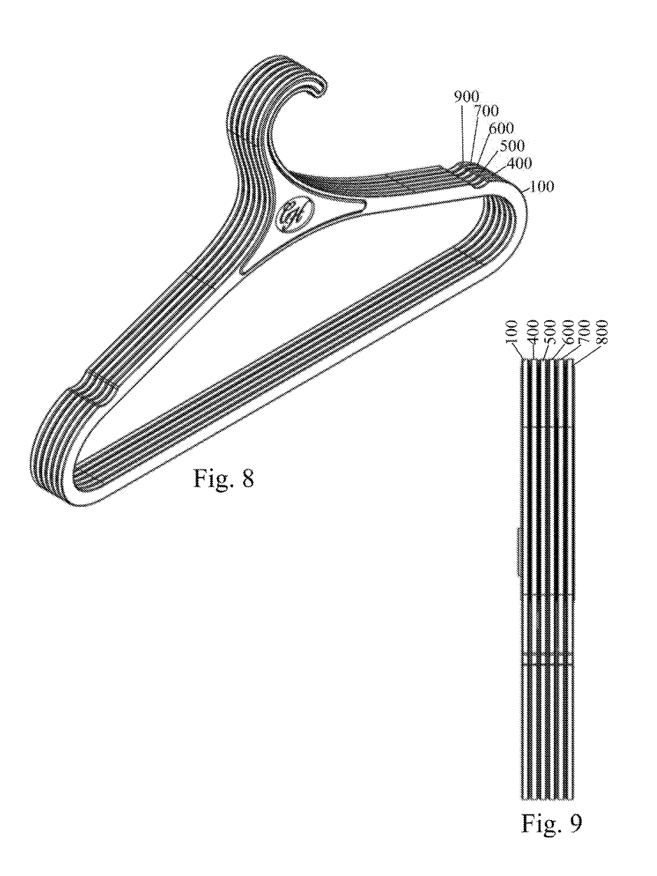

FIG. 8 illustrates hanger 100 in a stacked position with hangers 400, 500, 600, 700, and 800. As depicted in FIG. 9, the process of stacking each hanger involves inserting the protrusion of the first faceplate of a hanger into the recess of the second faceplate of another hanger. The process can be repeated to expand the overall thickness of the stacked hangers to support heavier articles of clothing. Each individual hanger is secured by the magnetic section.

Each magnetic hanger 100, 400, 500, 600, 700, and 800, when combined with one or more of the other of the other hangers, may be considered to constitute a unit of the stacked composite hanger to support heavier articles of clothing.

While a preferred embodiment of hanger is composed of three components (hanger body, first faceplate, and second faceplate) to allow the freedom to affect the aesthetic arrangement of the hanger and vary material properties (i.,e. color and finish) during the manufacturing process, the principles disclosed herein can be applied to manufacture a hanger in one or more pieces or a hanger with fixed components.

While the present invention has been described with reference to a preferred embodiment, which has been set forth in considerable detail for the purposes of making a complete disclosure of the invention, the preferred embodiment is merely exemplary and is not intended to be limiting or represent an exhaustive enumeration of all aspects of the invention. The scope of the invention, therefore, shall be defined solely by the claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A stackable hanger comprising:
a first faceplate and second faceplate;
said first faceplate being composed of a ferromagnetic material and including a protrusion;
said second faceplate being composed of a ferromagnetic material and including a recess;
a magnetic section positioned between the first faceplate and said second faceplate.

2. A stackable hanger system, comprising:
a first hanger having a first faceplate and a second faceplate, said first faceplate being composed of a ferromagnetic material and including a protrusion, said second faceplate being composed of a ferromagnetic material and including a recess, and a magnetic section positioned between the first faceplate and said second faceplate;
a second hanger having a first faceplate and a second faceplate, said first faceplate being composed of a ferromagnetic material and including a protrusion, said second faceplate being composed of a ferromagnetic material and including a recess, and a magnetic section positioned between the first faceplate and said second faceplate;
said first hanger and said second hanger being stacked on one another with the protrusion of the first hanger engaging the recess of the second hanger.

3. A system as in claim 2, further including a plurality of additional hangers corresponding to the first and second hangers and having the protrusions of hangers engaging recesses in other hangers to increase the thickness of the system to accommodate a particular weight of clothing.

4. A system as in claim 2, wherein said first and second hangers, when stacked with protrusions and said recesses engaged, each constituting a unit that forms a composite hanger.

5. A system as in claim 3, wherein said first and second hangers, when stacked with protrusions and said recesses engaged, each constituting a unit that forms a composite hanger.

6. A method of increasing the strength of a hanger arrangement comprising: stacking a plurality of hangers each having a first faceplate and second faceplate, said first faceplate being composed of a ferromagnetic material and including a protrusion, said second faceplate being composed of a ferromagnetic material and including a recess, and a magnetic section positioned between the first faceplate and said second faceplate; and engaging the protrusion of one of said hangers with the recesses of an adjacent hanger.
